(19) United States
(12) Patent Application Publication
(10) Pub. No.: US 2015/0199728 A1
(43) Pub. Date: Jul. 16, 2015

(54) APPARATUS AND METHOD FOR PROVIDING CUSTOMIZED ADVERTISEMENT RELATED TO TAILORED INTERACTIVE CONTENT

(71) Applicant: Electronics and Telecommunications Research Institute, Daejeon (KR)

(72) Inventor: HYUN JIN LEE, Daejeon (KR)

(21) Appl. No.: 14/591,094

(22) Filed: Jan. 7, 2015

(30) Foreign Application Priority Data
Jan. 16, 2014 (KR) 10-2014-0005626

(51) Int. Cl. G06Q 30/02

(52) U.S. Cl. CPC G06Q 30/0269; G06Q 30/0255; G06Q 30/0267

(57) ABSTRACT

A method for providing customized advertisements related to tailored interactive content in an apparatus for providing customized advertisements related to tailored interactive content that is connected to a telescreen terminal, the method including: receiving a request to run a promotion advertisement in a telescreen terminal from an advertiser; acquiring customized information that includes status information on surroundings of the telescreen terminal; selecting interactive content that includes the promotion advertisement based on the acquired customized information; and transmitting the selected interactive content to the telescreen terminal.

### CROSS-REFERENCE TO RELATED APPLICATION(S)

This application claims priority from Korean Patent Application No. 10-2014-0005626, filed on Jan. 16, 2014, in the Korean Intellectual Property Office, the entire disclosure of which is incorporated herein by reference for all purposes.

### BACKGROUND

1. Field

The following description relates generally to an apparatus and method for providing advertisements on big screens, and more particularly to an apparatus and method for providing customized advertisements related to tailored interactive content.

2. Description of the Related Art

A large digital signage system installed outside plays advertisements according to schedules. In the system, still image advertisements may be simply played in sequence, or video image advertisements may be played.

Such outdoor large screens were previously enough to attract people's attention in public spaces where people gather frequently. Recently, however, as people watch their smartphones even while walking, effects of one-way advertisements played on these large screens are being reduced.

Most advertisements provided in mobile phones are notification advertisements from applications, such as games, portals, SNS, and the like, with little efficiency in drawing people's attentions.

### SUMMARY

The present disclosure provides an apparatus and method for providing customized advertisements related to tailored interactive content by using a large screen in conjunction with a mobile terminal.

In one general aspect, there is provided a method for providing customized advertisements related to tailored interactive content in an apparatus for providing customized advertisements related to tailored interactive content that is connected to a telescreen terminal, the method comprising: receiving a request to run a promotion advertisement in a telescreen terminal from an advertiser; acquiring customized information that includes status information on surroundings of the telescreen terminal; selecting interactive content that includes the promotion advertisement based on the acquired customized information; and transmitting the selected interactive content to the telescreen terminal.

In another general aspect, there is provided a method for providing customized advertisements related to tailored interactive content in a telescreen terminal connected to an apparatus for providing customized advertisements related to tailored interactive content (hereinafter referred to as an “apparatus”), the method including: once interactive content including a promotion advertisement requested by a specific advertiser is received from the apparatus, displaying information on the interactive content; once information on users that request to participate in the interactive content is received from the apparatus, transmitting content access information to one or more mobile terminals; and in response to a request by the mobile terminal, executing the interactive content in conjunction with the mobile terminal.

In still another general aspect, there is provided an apparatus for providing customized advertisements related to tailored interactive content, the apparatus including: a web manager configured to receive a request to run a promotion advertisement in a telescreen terminal from an advertiser; a customized content recommender configured to acquire customized information that includes status information on surroundings of the telescreen terminal, and to select interactive content including the promotion advertisement based on the acquired customized information; and a content manager configured to transmit the selected interactive content to the telescreen terminal.

In yet another general aspect, there is provided a telescreen terminal, including: an advertisement receiver configured to display interactive content in response to receiving the interactive content, which includes a promotion advertisement requested by a specific advertiser, from an apparatus for providing customized advertisements related to tailored interactive content (hereinafter referred to as an “apparatus”); and an interactive content executor configured to transmit content access information to a mobile terminal in response to receiving information on a user requesting to participate in the interactive content from the apparatus, and to execute the interactive content in conjunction with the mobile terminal in response to a request from the mobile terminal.

### BRIEF DESCRIPTION OF THE DRAWINGS

FIG. 1 is a block diagram illustrating an example of a system including an apparatus for providing customized advertisements related to tailored interactive content according to an exemplary embodiment.

FIGS. 2 to 4 are signal flowcharts illustrating a method for providing customized advertisements related to tailored interactive content.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In the apparatus and method for providing customized advertisements related to tailored interactive content by using a telescreen terminal with a large screen installed in a place where many people gather, interactive content (e.g., multimedia player game, etc.), in which users may participate through mobile terminals, may be provided dynamically to attract people's attention, and encourages their participation to maximize the effect of promotion advertisement.

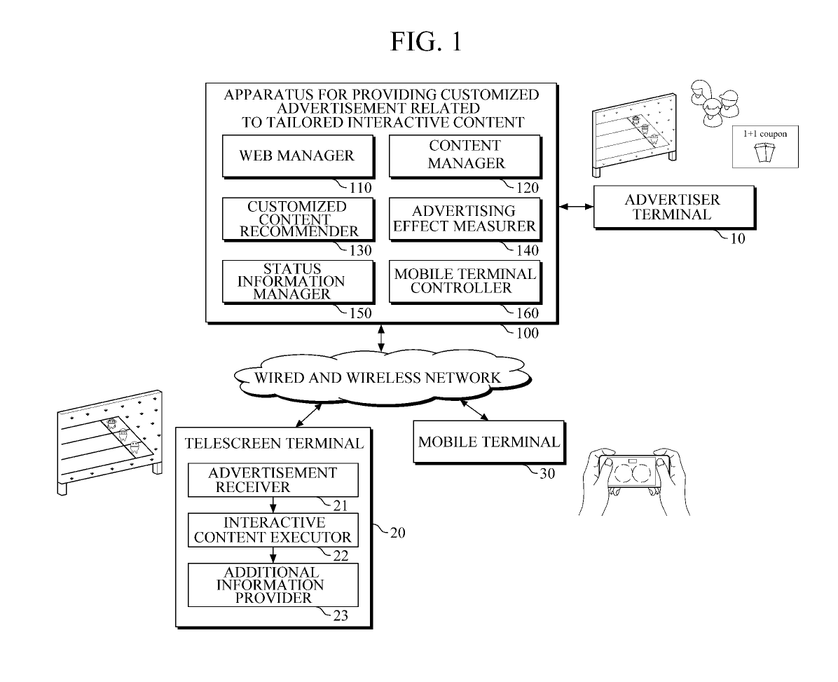

FIG. 1 is a block diagram illustrating an example of a system including an apparatus for providing customized advertisements related to tailored interactive content according to an exemplary embodiment.

Referring to FIG. 1, the apparatus 100 for providing customized advertisements related to interactive content (hereinafter referred to as “apparatus”) provides customized interactive advertisements to a telescreen terminal 20 through a wireless or wireless network in response to receiving a request for customized advertisements related to interactive content from an advertiser terminal 10, provides interactive content in conjunction with mobile terminals 30 of users positioned around the telescreen terminal 20, and provides additional information, such as coupons and the like, to the mobile terminals 30 according to execution results of interactive content.

In the present disclosure, it is construed that the advertiser terminal 10 may be connected not only to mobile communication terminals, such as a personal digital assistant (PDA), a smartphone, a navigation terminal, and the like, but also to web sites through the apparatus 100, such as a desk-top computer, a laptop computer, and the like, such that the advertiser terminal 10 may be applied to all types of apparatuses that may request promotion advertisements.

The telescreen terminal 20 may be a set-top box that includes an outdoor large screen, and may include an advertisement receiver 21, an interactive content executor 22, and an additional information provider 23.

Upon receiving interactive content that includes a promotion advertisement requested by a specific advertiser from the apparatus 100, the advertisement receiver 21 displays the received interactive content.

Upon receiving information on users requesting to participate in interactive content from the apparatus 100, the interactive content executor 22 transmits content access information to the mobile terminals 30, and executes interactive content in conjunction with the mobile terminals 30 in response to a request of the mobile terminals 30.

The additional information provider 23 transmits execution results of interactive content to the apparatus 100, receives from the apparatus 100 information on users that receive coupons, and transmits additional information to the mobile terminals 30 corresponding to the information on users that receive coupons, in which the additional information may include coupons or events.

The mobile terminal 30 is a mobile communication terminal, such as a PDA, a smartphone, a navigation terminal, and the like, and it is construed that the mobile terminal 30 may participate in interactive content executed in the telescreen terminal 20.

The apparatus 100 for providing customized advertisements related to tailored interactive content specifically includes a web manager 110, a content manager 120, a customized content recommender 130, an advertising effect measurer 140, a status information manager 150, and a mobile terminal controller 160.

The web manager 110 receives a request to run a promotion advertisement in the telescreen terminal 20 from an advertiser through a website. The website may be configured to guide an advertiser to upload one or more types of interactive content including an advertisement, and additional information including a logo and coupons. Further, the web manager 110 performs a log-in authentication of an advertiser.

The content manager 120 stores and manages promotion advertisement information of a specific advertiser that is transmitted from the web manager 110, and transmits interactive content selected by the customized content recommender 130 to the telescreen terminal 20.

The customized content measurer 130 acquires customized information that includes status information on surroundings of the telescreen terminal 20, and selects interactive content that includes a promotion advertisement based on the acquired customized information. The customized information further includes a history of an advertising effect of specific interactive content, which is acquired from the advertising effect measurer 140. Further, status information, which is acquired by the status information manager 150, may include information on at least one of the following: age/gender of advertisement viewers positioned around the telescreen terminal 20, advertising time, weather, users' reactions to interactive content, and a number of viewers.

The advertising effect measurer 140 acquires history information on advertising effects of various types of interactive content, and stores and manages the acquired information, e.g., history information on whether a specific game is effective with respect to a certain gender or a certain age group, and the like, among various types of interactive content.

The status information manager 150 acquires information of viewers positioned around the telescreen terminal 20. To this end, a sensing device, such as a camera, a sensor, and the like, are installed around the telescreen terminal 20, and information acquired from the installed sensing device is analyzed to acquire information on advertisement viewers.

In response to receiving, from the mobile terminal 30, a request for participation in interactive content that is output to the telescreen terminal 20, the mobile terminal controller 160 performs a log-in process of a user of the mobile terminal 30, and transmits user information to the customized content recommender 130. Then, the customized content recommender 130 collects information on a user of the mobile terminal 30, and transmits the collected user information to the telescreen terminal 20. Further, upon receiving execution results of interactive content from the telescreen terminal 20, the customized content recommender 130 provides information on coupon recipients according to the execution results of interactive content.

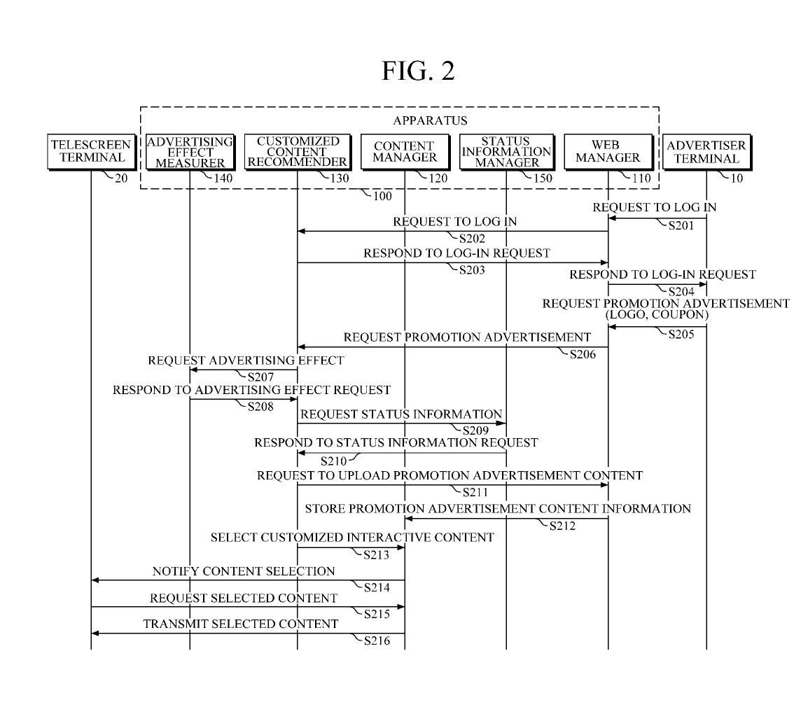

FIGS. 2 to 4 are signal flowcharts illustrating a method for providing customized advertisements related to tailored interactive content.

The method for providing customized advertisements related to tailored interactive content includes: receiving a request to run a promotion advertisement in a telescreen terminal from an advertiser; acquiring customized information that includes status information on surroundings of the telescreen terminal; selecting interactive content that includes the promotion advertisement based on the acquired customized information; and transmitting the selected interactive content to the telescreen terminal.

Additionally, in response to receiving, from a mobile terminal, a request for participation in interactive content that is output to the telescreen terminal, the method may further include collecting information on a user of the mobile terminal; and transmitting the collected user information to the telescreen terminal.

Further, upon receiving execution results of interactive content from the telescreen terminal, the method may further include providing information on coupon recipients based on the execution results of interactive content.

FIG. 2 is a signal flowchart to explain a process of transmitting interactive content, which includes a promotion advertisement requested by an advertiser, to a telescreen terminal according to an exemplary embodiment.

Referring to FIG. 2, an advertiser requests to log in the apparatus for providing customized advertisements related to tailored interactive content in S201. Then, the web manager 110 of the apparatus 100 for providing customized advertisements related to tailored interactive content transmits the request to the customized content recommender 130 in S202, and the customized content recommender 130 performs a log-in process of the advertiser to respond to the advertiser terminal 10 in S203 and S204.

The advertiser requests a promotion advertisement on a website provided by the web manager 110 in S205. At this point, a logo, a coupon, and the like are selected for a promotion advertisement. Then, the web manager 110 transmits the request for a promotion advertisement to the customized content recommender 130 in S206.

The customized content recommender 130 acquires history information on advertising effects and status information to maximize a promotion advertisement effect. That is, the customized content recommender 130 transmits a request for history information on advertising effects to the advertising effect measurer 110 in S207, and receives the requested history information on advertising effects in S208.

Further, the customized content recommender 130 transmits a request for status information to the status information manager 150 in S209, and receives the requested status information in S210. The status information may include age/gender of viewers positioned around the telescreen terminal 20, advertising time, weather, users' reactions to interactive content, and the like.

The customized content recommender 130 transmits a request by an advertiser to upload promotion advertisement content to the web manager 110 in S211, and the web manager 110 uploads and stores the promotion advertisement content input through a website in the content manager 120 in S212. At this point, content (e.g., logo, coupon, etc.) required for the promotion advertisement is uploaded to the content manager 120.

Based on the history information on advertising effects and status information, the customized content recommender 130 selects customized interactive content stored in the content manager 120 in S213. Then, the content manager 120 notifies the telescreen terminal 20 in S214 that customized interactive content has been selected. Thereafter, the telescreen terminal 20 transmits a request for the selected content to the content manager 120 in S215, and downloads the content in S216.

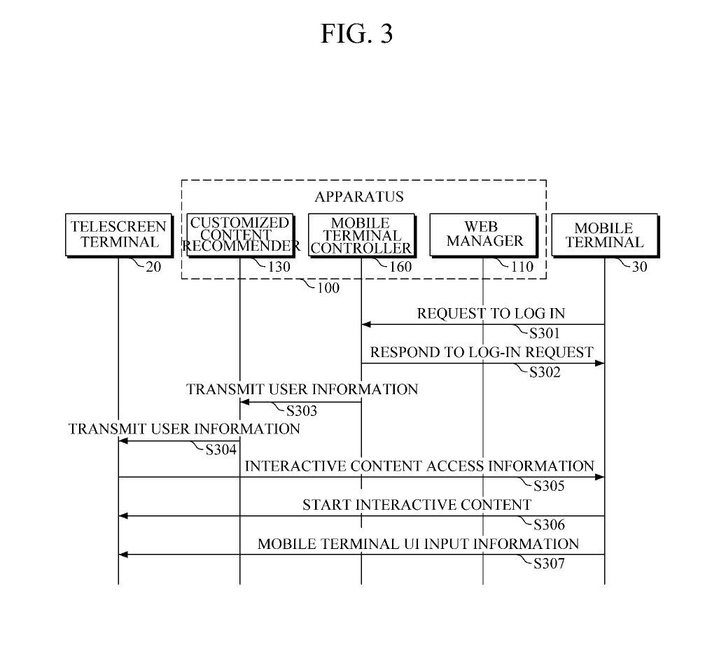

FIG. 3 is a signal flowchart to explain a process of participation of a user in interactive content for a promotion advertisement by using a mobile terminal.

Referring to FIG. 3, in order to access interactive content, a user transmits a log-in request to the mobile terminal controller 160 of the apparatus 100 using the mobile terminal 30 in S301. Upon authenticating the user, the mobile terminal controller 160 responds to the log-in request in S302.

The mobile terminal controller 160 transmits information on the authenticated user to the telescreen terminal 20 through the customized content recommender 130 in S303 and S304.

The telescreen terminal 20 transmits interactive content access information to the mobile terminal 30 in S305 to enable the mobile terminal 30 to request direct interaction. The interactive content access information may act as a pass (token) that is generally used in a communication system. In a case where a plurality of mobile terminals participate in a game, the mobile terminal 30, which serves as a master, transmits a request for starting interactive content to the telescreen terminal 20 in S306. The game gets started in S307 as soon as mobile terminals participating in the game transmit game UI input information to the telescreen terminal 20.

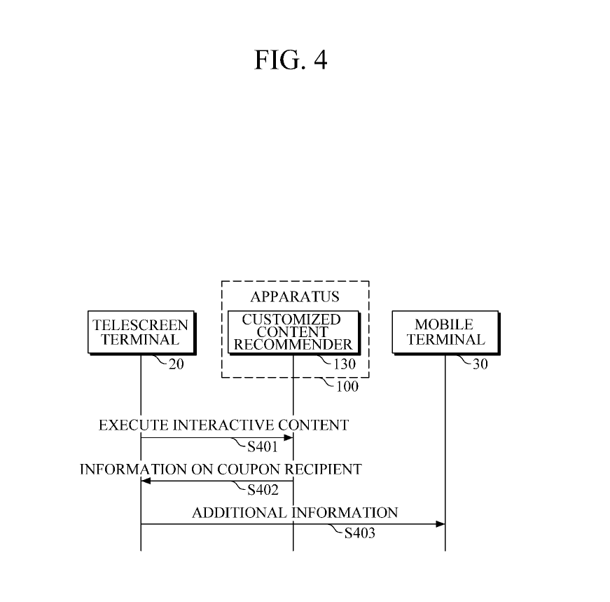

FIG. 4 is a signal flowchart to explain a process of issuing an event coupon customized for users accessing interactive content according to an exemplary embodiment.

Referring to FIG. 4, as execution of interactive content ends, the telescreen terminal 20 transmits execution results of interactive content to the customized content recommender 130 in S401. Then, the customized content recommender 130 may issue an event coupon to some or all of the participants based on the execution results of interactive content. As information (gender, age, etc.) of participants are already known, coupons customized for the participants may be provided. To this end, the customized content recommender 130 transmits information on coupon recipients to the telescreen terminal 20 in S402. The telescreen terminal 20 issues event coupons to the mobile terminals 30 in S403.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for providing customized advertisements related to tailored interactive content in an apparatus for providing customized advertisements related to tailored interactive content that is connected to a telescreen terminal, the method comprising:
receiving a request to run a promotion advertisement in a telescreen terminal from an advertiser;
acquiring customized information that includes status information on surroundings of the telescreen terminal;
selecting interactive content that includes the promotion advertisement based on the acquired customized information; and
transmitting the selected interactive content to the telescreen terminal.

2. The method of claim 1, wherein the receiving of the request comprises receiving one or more types of interactive content including the advertisement of the advertiser, and additional information including a logo and a coupon.

3. The method of claim 1, wherein the customized information further includes history information on advertising effects.

4. The method of claim 1, wherein the status information includes information on at least one of the following: age/gender of advertisement viewers positioned around the telescreen terminal, advertising time, weather, users' reactions to interactive content, and a number of viewers.

5. The method of claim 1, further comprising:
in response to receiving, from the mobile terminal, a request for participating in the interactive content that is output to the telescreen terminal, collecting information on a user of the mobile terminal; and
transmitting the collected information on the user to the telescreen terminal.

6. The method of claim 1, further comprising, in response to receiving execution results of the interactive content from the telescreen terminal, providing information on coupon recipients according to the execution results of the interactive content.

7. A method for providing customized advertisements related to tailored interactive content in a telescreen terminal connected to an apparatus for providing customized advertisements related to tailored interactive content (hereinafter referred to as an “apparatus”), the method comprising:
once interactive content including a promotion advertisement requested by a specific advertiser is received from the apparatus, displaying information on the interactive content;
once information on users that request to participate in the interactive content is received from the apparatus, transmitting content access information to one or more mobile terminals; and
in response to a request by the mobile terminal, executing the interactive content in conjunction with the mobile terminal.

8. The method of claim 7, further comprising:
transmitting execution results of the interactive content to the apparatus;
receiving information on coupon recipients from the apparatus; and
transmitting additional information to the one or more mobile terminals corresponding to the coupon recipients.

9. The method of claim 8, wherein the additional information includes coupons or events.

10. An apparatus for providing customized advertisements related to tailored interactive content, the apparatus comprising:
a web manager configured to receive a request to run a promotion advertisement in a telescreen terminal from an advertiser;
a customized content recommender configured to acquire customized information that includes status information on surroundings of the telescreen terminal, and to select interactive content including the promotion advertisement based on the acquired customized information; and
a content manager configured to transmit the selected interactive content to the telescreen terminal.

11. The apparatus of claim 10, wherein the web manager receives one or more types of interactive content that includes the advertisement of the advertiser, and additional information that includes logos and coupons.

12. The apparatus of claim 10, wherein the customized information further includes history information on advertising effects.

13. The apparatus of claim 10, wherein the status information includes age/gender of advertisement viewers positioned around the telescreen terminal, advertising time, weather, users' reactions to interactive content, and a number of viewers.

14. The apparatus of claim 10, further comprising a mobile terminal controller that receives, from the mobile terminal, a request for participating in the interactive content that is output to the telescreen terminal; and
wherein the customized content recommender collects information on a user of the mobile terminal, and transmits the collected information to the telescreen terminal.

15. The apparatus of claim 10, wherein in response to receiving execution results of the interactive content form the telescreen terminal, the customized content recommender provides information on coupon recipients based on the execution results of the interactive content.

16. A telescreen terminal, comprising:
an advertisement receiver configured to display interactive content in response to receiving the interactive content, which includes a promotion advertisement requested by a specific advertiser, from an apparatus for providing customized advertisements related to tailored interactive content (hereinafter referred to as an “apparatus”); and
an interactive content executor configured to transmit content access information to a mobile terminal in response to receiving information on a user requesting to participate in the interactive content from the apparatus, and to execute the interactive content in conjunction with the mobile terminal in response to a request from the mobile terminal.

17. The telescreen terminal of claim 16, further comprising an additional information provider configured to transmit execution results of the interactive content to the apparatus, to receive information on coupon recipients from the apparatus, and to transmit additional information to mobile terminals corresponding to the information on coupon recipients.

18. The telescreen terminal of claim 17, wherein the additional information includes coupons or events.
